(19) United States
(12) Patent Application Publication
(10) Pub. No.: US 2011/0014806 A1
(43) Pub. Date: Jan. 20, 2011

(54) LAMP CONNECTOR, BACKLIGHT DEVICE AND LIQUID CRYSTAL DISPLAY DEVICE

(75) Inventor: Daisuke Teragawa, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/921,634

(22) PCT Filed: Nov. 11, 2008
(86) PCT No.: PCT/JP2008/070460

§ 371 Date: Sep. 9, 2010

(30) Foreign Application Priority Data
Mar. 13, 2008 (JP) 2008-063781

(51) Int. Cl. H01R 33/02

(52) U.S. Cl. 439/239

(57) ABSTRACT

A valve holding portion including a pair of elastic deformation portions which is arranged opposite each other, whose gap is elastically opened and which sandwiches the valve and a feed portion that is coupled to at least one of the elastic deformation portions and that feeds electric power to the lead wire are included. The feed portion includes a lead contact portion formed such that, when the pair of elastic deformation portions holds the valve, comes into contact with the lead wire.

### TECHNICAL FIELD

The present invention relates to a lamp connector holding a lamp, a backlight device incorporating this lamp connector and a liquid crystal display device incorporating this backlight device.

### BACKGROUND ART

In a liquid crystal display device, light emitted from a backlight device arranged on the back surface of a liquid crystal panel is partially interrupted by the liquid crystal panel, and an image is displayed on the side of the front surface of the liquid crystal panel. In a large liquid crystal display device, a direct type backlight device where light sources using lamps or the like are arranged on the back surface of the liquid crystal panel is often utilized.

The lamp and the backlight device will be described with reference to accompanying drawings. FIG. 10 is an enlarged cross-sectional view showing a state where a lamp is attached to a lamp connector employed in a conventional backlight device; FIG. 11 is an enlarged cross-sectional view taken along a line perpendicular to FIG. 10; and FIG. 12 is a diagram showing the procedure of fitting the lamp to the conventional lamp connector. For convenience, in FIG. 10, one end of the lamp is only shown, but the other end, which is not shown, is attached to the similar lamp connector. As shown in FIG. 10, the lamp 3 has: a cylindrical valve 31 made of glass; a sealing portion 32 that is formed at each end of the valve 31 and that seals the valve 31; and a lead wire 33 that penetrates the sealing portion 32.

The lead wire 33 has an inner lead 331 arranged inside the valve 31 and an outer lead 332 protruding outside the valve 31. The lamp 3 is lit by producing a discharge between the inner leads 331 on both ends inside the valve 31. Appropriate amounts of mercury and an inert gas (such as argon, neon or mixed gas) are sealed in the lamp 3, and the pressure inside the lamp 3 is kept lower than that of the air. The lead wire 33 is fixed to the sealing portion 32 by soldering. The lead wire 33 and the sealing portion 32 are soldered together, and this maintains the hermeticity of the valve 31.

As shown in FIGS. 10 and 11, in the backlight device, both ends of the lamp 3 are fitted through the lamp connectors 96. The lamp connector 96 with a rectangular bottom surface has: a housing 961 that is made of resin and that is vertically formed from three sides of the bottom surface; and metal fittings 962 that protrude from the middle of the bottom surface of the housing 961 and that sandwich and hold the outer lead 332. The metal fittings 962 are formed of an elastic metal, and are formed symmetrically with respect to a line extending in the direction of the protrusion. The pair of metal fittings 962 sandwiches and holds the outer lead 332, and also serves to feed electric power to the lead wires 33.

As shown in FIG. 12, the lamp 3 is fitted by arranging the outer lead 332 on an end of the gap between the metal fittings 962 and pressing the valve 31 to push the outer lead 332 into the gap between the metal fittings 962. Here, the outer lead 332 often receives a large force from the metal fittings 962. When the large force is applied to the outer lead 332, a gap may be formed between the lead wire 33 and the sealing portion 32. If the gap is formed between the lead wire 33 and the sealing portion 32, since the inside of the valve 31 is lower in pressure than the air, air flows into the valve 31 from the air. It is likely that the lamp 3 fails to be lit, the brightness of the backlight device is reduced and inconsistencies in brightness occur.

To overcome this problem, a product is proposed in which metal fittings are formed to be wider than an outer lead, a separately prepared fixing member is used to close the metal fittings with the outer lead arranged between the metal fittings and thus the metal fittings hold the outer lead (JP-A-2007-48715). In this way, it is possible to reduce a large force applied to the outer lead when the lamp is fitted, to prevent air from flowing into the lamp and to reduce the occurrence of the failure of the lamp to be lit.

A product is also proposed in which conductive caps are fitted over both side ends of a lamp to cover a glass tube, the caps and lead wires are electrically connected together, and then metal fittings hold the caps (JP-A-2007-311260).

Patent document 1: JP-A-2007-48715
Patent document 2: JP-A-2007-311260

### DISCLOSURE OF THE INVENTION

### Problems to be Solved by the Invention

However, in the invention disclosed in JP-A-2007-48715, it is necessary to separately prepare, in a lamp attachment portion, the fixing member in addition to the metal fittings. A step of attaching the fixing member to the metal fittings is also needed, and thus it is very time-consuming to produce and attach the fixing member.

When the cap is attached as in the invention disclosed in Japanese Patent Application No. 2007-311260, a force applied to the lead wire is reduced as a result of the cap being held by the metal fittings, and thus it is possible to reduce the production of a gap between the lead wire and the glass tube. However, since it is necessary to additionally prepare and attach the cap, it is very time-consuming to do so. If the cap and the outer lead fail to be electrically connected together, a sufficient amount of power is not supplied, and this results in the failure of the lamp to be lit. Thus, it is likely that the brightness is reduced and inconsistencies in brightness occur.

It is an object of the present invention to provide a lamp connector that has a simple configuration, that prevents the application of an excessive force to a lead wire and thus the formation of a poor joint between a lamp and a glass tube and that consequently maintains the hermeticity of the lamp.

It is another object of the invention to provide a backlight device and a liquid crystal display device which have a simple configuration and reduce the failure of a lamp to be lit and in which it is unlikely that the brightness is reduced and inconsistencies in brightness occur.

### Means for Solving the Problem

To achieve the above objects, according to one aspect of the present invention, there is provided a lamp connector that holds a valve in which a low-pressure gas is sealed and an end of a lamp including a lead wire protruding from each end of the valve, the lamp connector including: a valve holding portion including a pair of elastic deformation portions which is arranged opposite each other, whose gap is elastically opened and which sandwiches the valve; and a feed portion that is coupled to at least one of the elastic deformation portions and that feeds electric power to the lead wire, in which the feed portion includes a lead contact portion formed such that, when the pair of elastic deformation portions holds the valve, comes into contact with the lead wire.

With this configuration, since, when the lamp is fitted to the lamp connector, the valve of the lamp is held by the valve holding portion, and the lead wire comes into contact with the lead contact portion of the feed portion, the lead wire is unlikely to be strongly pressed by the feed portion at the time of the fitting of the lamp. Thus, it is possible to prevent the formation of a poor interface between the valve of the lamp and the lead wire, the entrance of air into the valve and the failure of the lamp.

Since the lamp is fitted to the lamp connector by holding the valve with the valve holding portion, even if a large force resulting from the load of the lamp itself, vibration or the like is applied to the lamp, the valve holding portion can accept such a large force. Hence, it is possible to reduce a force acting between the lead wire and the lead contact portion. Thus, it is possible to prevent the formation of a poor interface between the valve of the lamp and the lead wire, the entrance of air into the valve and the failure of the lamp.

As described above, the failure of the lamp is prevented, and thus it is possible to provide a backlight device having a high and uniform brightness. Moreover, the use of the backlight device in the liquid crystal display device prevents insufficient brightness of an image displayed on the liquid crystal display device and inconsistencies in brightness.

Furthermore, both ends of the valve are held by the valve holding portion, and thus it is possible to effectively release heat produced from the valve through the valve. This makes it possible to prevent the heat-induced deformation of an optical member (such as a reflective plate or a diffusion plate) arranged near the valve and the heat-induced failure of an electronic member (such as a transistor).

In the configuration described above, the valve holding portion and the feed portion may be integrally formed of a conductive material, and electric power may be fed to the feed portion through the valve holding portion. Examples of the conductive material include conductive metal plates such as iron, aluminum and copper.

With this configuration, since both the valve holding portion and the feed portion are formed with a conductive member, it is possible to prevent a discharge produced between the valve holding portion and the feed portion when they are arranged apart. Moreover, since the valve holding portion and the feed portion are integrally formed, it is possible to reduce steps necessary for production. The reduction of the production steps allows the reduction of errors produced in the production steps and the increase of the yield.

In the configuration described above, the feed portion may include: a pair of lead contact portions arranged opposite each other; and a coupling portion that couples the pair of lead contact portions to the pair of elastic deformation portions, respectively, and the lead contact portions may be formed to sandwich the lead wire in the same direction as a direction in which the elastic deformation portions sandwich the valve.

Since the arrangement is made such that the pair of lead contact portions sandwich the lead wire, the lead contact portions are unlikely to separate from the lead wire. Thus, it is possible to prevent continuous or intermittent stopping of power supply to the lamp, and the complete extinction of and the blinking of the lamp.

In the configuration described above, the feed portion may include one lead contact portion and a coupling portion that couples the lead contact portion to one of the elastic deformation portions. The lead contact portion may be formed to face the elastic deformation portion to which the coupling portion is coupled. The lead contact portion may be formed to extend in a direction in which the elastic deformation portions sandwich the valve.

### ADVANTAGES OF THE INVENTION

With the present invention, it is possible to provide a lamp connector that has a simple configuration, that prevents the application of an excessive force to a lead wire and thus the formation of a poor joint between a lamp and a glass tube and that consequently maintains the hermeticity of the lamp.

With the present invention, it is possible to provide a backlight device and a liquid crystal display device which have a simple configuration and reduce the failure of a lamp to be lit and in which it is unlikely that the brightness is reduced and inconsistencies in brightness occur.

### BRIEF DESCRIPTION OF DRAWINGS

FIG. 1 A cross-sectional view of an example of a liquid crystal display device incorporating a backlight device according to the present invention;

FIG. 2 A front view of an example of the backlight device according to the invention;

FIG. 3 An enlarged perspective view of an example of a lamp connector of the invention;

FIG. 4 A cross-sectional view taken along line X-X with a lamp fitted to the lamp connector shown in FIG. 3;

FIG. 5 A cross-sectional view taken along line Y-Y with the lamp fitted to the lamp connector shown in FIG. 3;

FIG. 6 A front view showing a state where the lamp is fitted to the lamp connector shown in FIG. 3;

FIG. 7A A schematic side view showing a state immediately before the lamp is fitted to the lamp connector;

FIG. 7B A schematic side view showing a state where the lamp is in the middle of being fitted to the lamp connector;

FIG. 7C A schematic side view showing a state where the lamp is fitted to the lamp connector;

FIG. 8 A schematic side view showing a state where the lamp is fitted to a lamp connector according to the invention;

FIG. 9 A schematic side view showing a state where the lamp is fitted to a lamp connector according to the invention;

FIG. 10 An enlarged cross-sectional view showing a state where a lamp is fitted to a lamp connector employed in a conventional backlight device;

FIG. 11 An enlarged cross-sectional view of the conventional backlight device taken along a line perpendicular to FIG. 10; and

FIG. 12 A diagram showing a procedure of fitting the lamp to a conventional lamp connector.

### LIST OF REFERENCE SYMBOLS

1 Shield
2 Reflective plate
3 Lamp
31 Valve
32 Sealing portion
33 Lead wire
331 Inner lead
332 Outer lead
4 Diffusion plate
5 Lamp holder
6 Lamp connector
61 Housing
62 Valve holding portion
620 Insertion opening
621 Elastic deformation portion
622 Valve guide portion
623 Valve support edge portion
624 Valve support projection portion
625 Connection portion
63 Feed portion
631 Lead contact portion
632 Coupling portion
633 Lead contact portion
634 Coupling portion

### BEST MODE FOR CARRYING OUT THE INVENTION

Embodiments of the present invention will be described below with reference to the accompanying drawings.

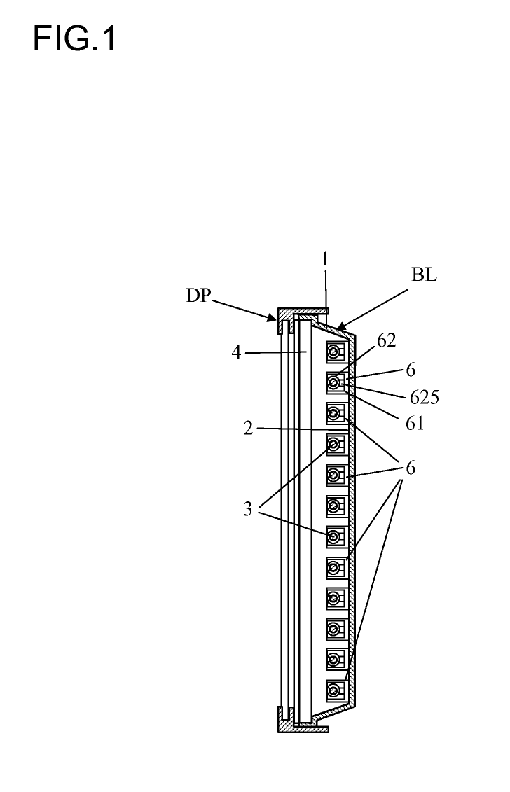

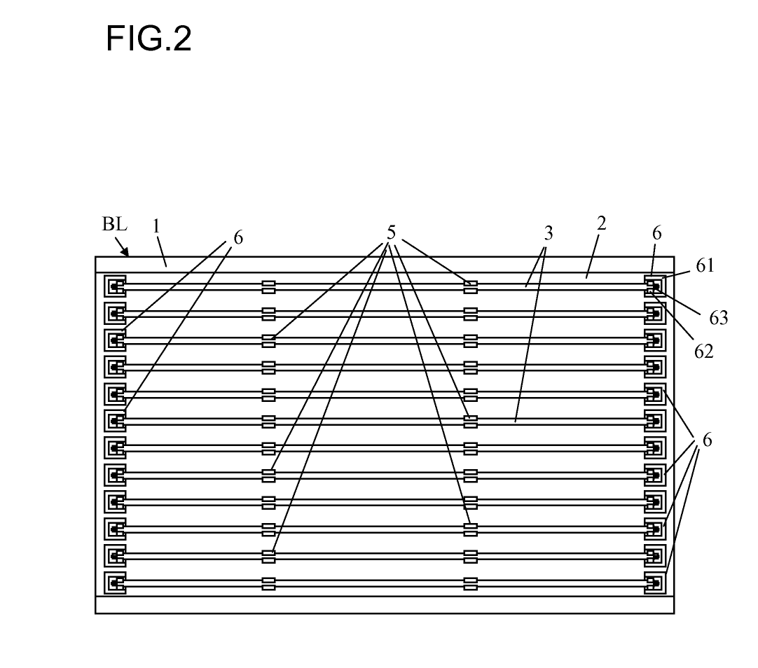

FIG. 1 is a cross-sectional view of an example of a liquid crystal display device according to the invention; FIG. 2 is a front view of an example of a backlight device according to the invention.

As shown in FIG. 1, the liquid crystal display device has the backlight device BL and a liquid crystal panel DP. The liquid crystal display device is assembled by attaching and fixing the liquid crystal panel DP having a frame fitted thereto to the side of the front surface of the backlight device BL.

As shown in FIGS. 1 and 2, the backlight device BL has at least a shield 1, a reflective plate 2, lamps 3, a diffusion plate 4, lamp holders 5 and lamp connectors 6. The shield 1 is a rectangular housing whose front surface is open, and places the reflective plate 2 and a plurality of lamps 3 therewithin. The reflective plate 2 reflects light emitted from the lamps 3, and is a sheet-shaped member having a white reflective surface. The reflective plate 2 is positioned and fixed in a predetermined position of the bottom surface of the shield 1.

The lamps 3 are light sources of the backlight device BL. A plurality of lamps 3 are provided in the backlight device BL. The longitudinal direction of the lamps 3 is parallel to the long side of the backlight device BL, and the lamps 3 are spaced a predetermined distance apart in the lateral direction.

On the side of the front surface of the shield 1, the diffusion plate 4 is arranged to cover the opening. The diffusion plate 4 diffuses both light emitted from the lamps 3 and light that is emitted from the lamps 3 and that is then reflected off the reflective plate 2, and thereby can make uniform or substantially uniform brightness within the same plane.

The lamp holder 5 is a holding member that holds a middle portion of the lamp 3 in order to prevent the flexure of the lamp 3 resulting from a static load such as the load of the lamp 3 itself and the deformation of the lamp 3 resulting from a dynamic load such as vibration. The lamp connector 6 supplies electric power to the lamp 3 to light it. In the lamp 3, two parts of the middle portion are held by the lamp holders 5, and both ends are held by the lamp connectors 6.

### First Embodiment

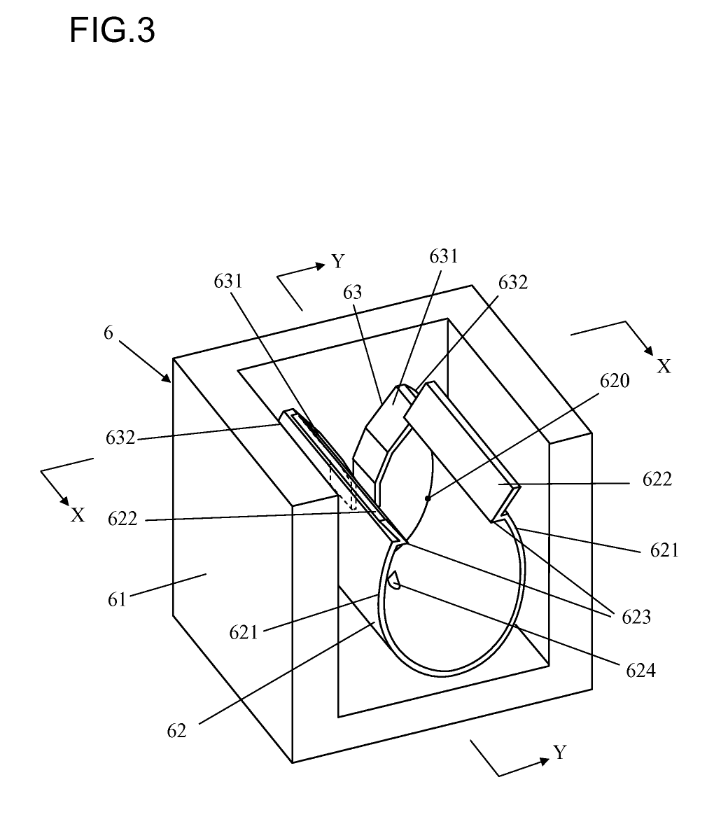

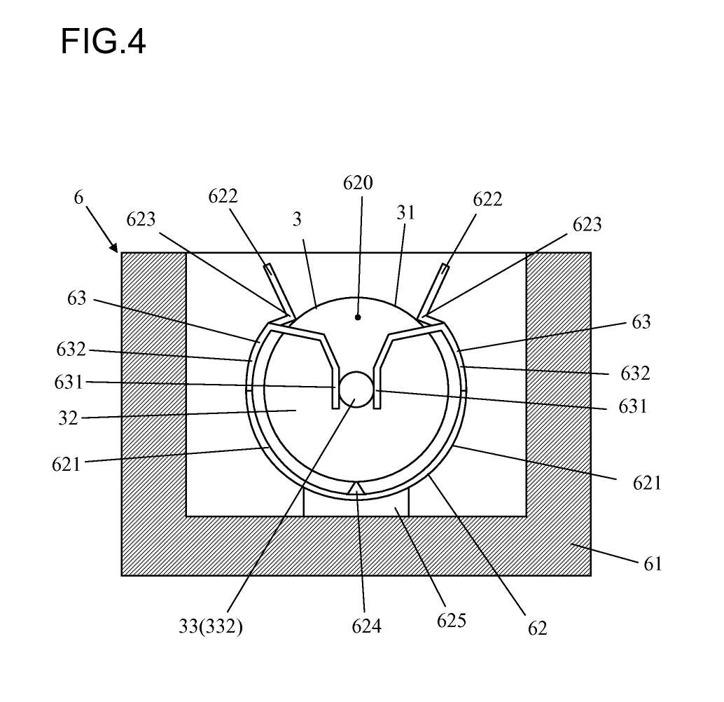

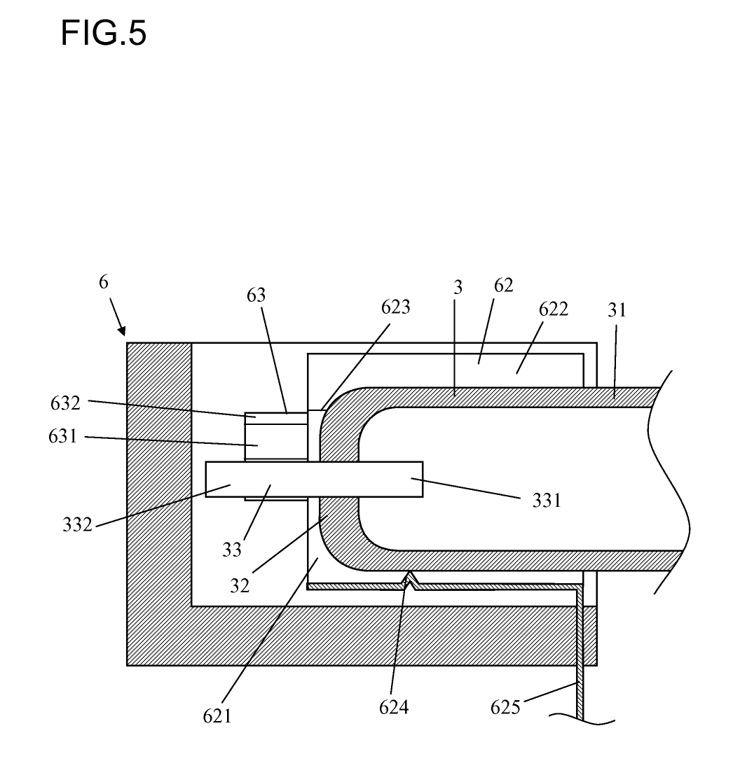

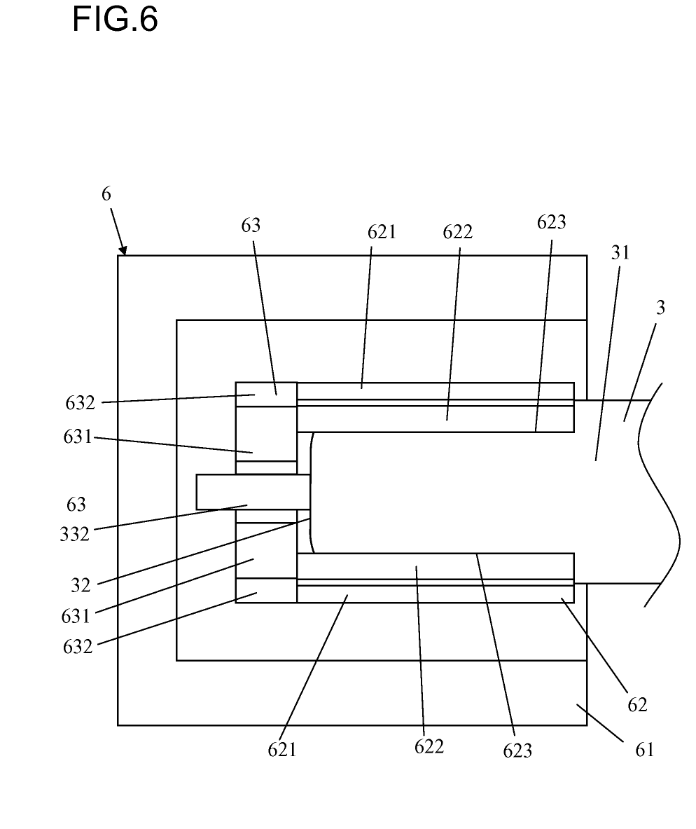

The lamp connector according to the present invention will be described in detail. FIG. 3 is an enlarged perspective view of an example of the lamp connector of the invention; FIG. 4 is a cross-sectional view taken along line X-X with the lamp fitted to the lamp connector shown in FIG. 3; FIG. 5 is a cross-sectional view taken along line Y-Y with the lamp fitted to the lamp connector shown in FIG. 3; and FIG. 6 is a front view showing a state where the lamp is fitted to the lamp connector shown in FIG. 3.

Although, as shown in FIG. 5, the lamp 3 used here is a cold cathode fluorescent lamp (CCFL), the lamp 3 is not limited thereto. The lamp 3 has: a cylindrical valve 31 made of glass; a sealing portion 32 that is formed at each end of the valve 31 and that seals the valve 31; and a lead wire 33 that is made of metal and that penetrates the sealing portion 32.

The lead wire 33 of the lamp 3 has an inner lead 331 arranged inside the valve 31 and an outer lead 332 protruding outside the valve 31. The lead wire 33 is fixed to the sealing portion 32 by soldering. The lead wire 33 and the sealing portion 32 are soldered together, and this maintains the hermeticity of the valve 31. The lamp 3 is lit by producing a discharge between the inner leads 331 on both ends inside the valve 31. Appropriate amounts of mercury and an inert gas (such as argon, neon or mixed gas) are sealed in the valve 31, and the pressure inside the valve 31 is kept lower than that of the air.

As shown in FIG. 3, the lamp connector 6 includes: a housing 61 having an upright wall that is vertically formed from three sides of a rectangular bottom surface; a valve holding portion 62 that holds the valve 31 of the lamp 3; and feed portions 63 that sandwich the lead wire 33 of the lamp 3. Although the housing 61 used here is an integrally-molded resin product, the housing 61 is not limited thereto. The outside surfaces of the housing 61 are white or transparent so that light emitted from the lamps 3 is reflected more efficiently.

As shown in FIGS. 4, 5 and 6, the valve holding portion 62 and the feed portions 63 are formed integrally with each other. Although the valve holding portion 62 and the feed portions 63 used here are formed by bending a conductive metal plate (made of iron, copper, aluminum or the like), they may be formed otherwise.

The valve holding portions 62 hold both ends of the valve 31. The valve holding portion 62 extends in an axial direction, and is a cylindrical member that has a discontinuous portion in its circumference and that is C-shaped in cross-section. The valve holding portion 62 has a pair of elastic deformation portions 621 arranged opposite each other; when the valve 31 is held, the discontinuous portion in the circumference of the valve holding portion 62 is used as an insertion opening 620 through which the valve 31 is passed.

The valve holding portion 62 includes: valve guide portions 622 that are coupled with the pair of elastic deformation portions 621 and that are formed to extend outward in a radial direction of the valve holding portion 62 from the insertion opening 620; a pair of valve support edge portions 623 that is a coupling portion which couples the elastic deformation portions 621 and the valve guide portions 622, that protrudes inward of the valve holding portion 62, that extends in the axial direction of the valve holding portion 62 and that is formed into a sharp edge; and a valve support projection portion 624 that projects inward from a portion arranged opposite the insertion opening 620 of the valve holding portion 62. As shown in FIG. 4, the insertion opening 620 is a gap formed between the valve support edge portions 623.

At least one of the pair of valve support edge portions 623 may be provided with a projection portion such that the valve 31 is supported at one point. When the valve 31 is supported at one point, since the valve 31 can be stably supported even if the valve support edge portions 623 are not formed parallel to each other with high accuracy, the valve holding portion 62 can be produced easily.

The valve support projection portion 624 is shaped to support the valve 31 at one point. In order to stably support the valve 31, the valve support projection portion 624 is preferably formed to support part close to an end of the valve 31. As with the valve support edge portion 623, the valve support projection portion 624 may be formed into a sharp edge extending in the axial direction of the valve holding portion 62. When the valve support projection portion 624 is formed into a sharp edge, since the valve 31 is supported along a line by each sharp edge, it is possible to support the valve 31 more stably. However, since it is necessary to bring it into accurate contact with an outer circumference of the valve 31, the sharp edge needs to be molded such that its position is accurate.

The feed portions 63 protrude toward its tip ends from the ends of the pair of elastic deformation portions 621 in the axial direction. The feed portions 63 have: a pair of lead contact portions 631 that sandwiches the lead wire 33 to come into contact with each other; and a pair of coupling portions 632 that is formed between the lead contact portion 631 and the elastic deformation portion 621.

The valve holding portion 62 and the feed portions 63 are an integrally-molded member that is formed by bending a conductive metal plate. The valve holding portion 62 and the feed portions 63 are formed such that they can be electrically continuous with each other; the valve holding portion 62 has a connection portion 625 that connects to a wiring board (not shown) for supplying power. Although the wiring board used here is a board incorporating an inverter circuit, the wiring board is not limited thereto. Power supplied from the wiring board to the connection portion 625 is fed to the lead wire 33 (outer lead 332) through the valve holding portion 62 and the feed portions 63.

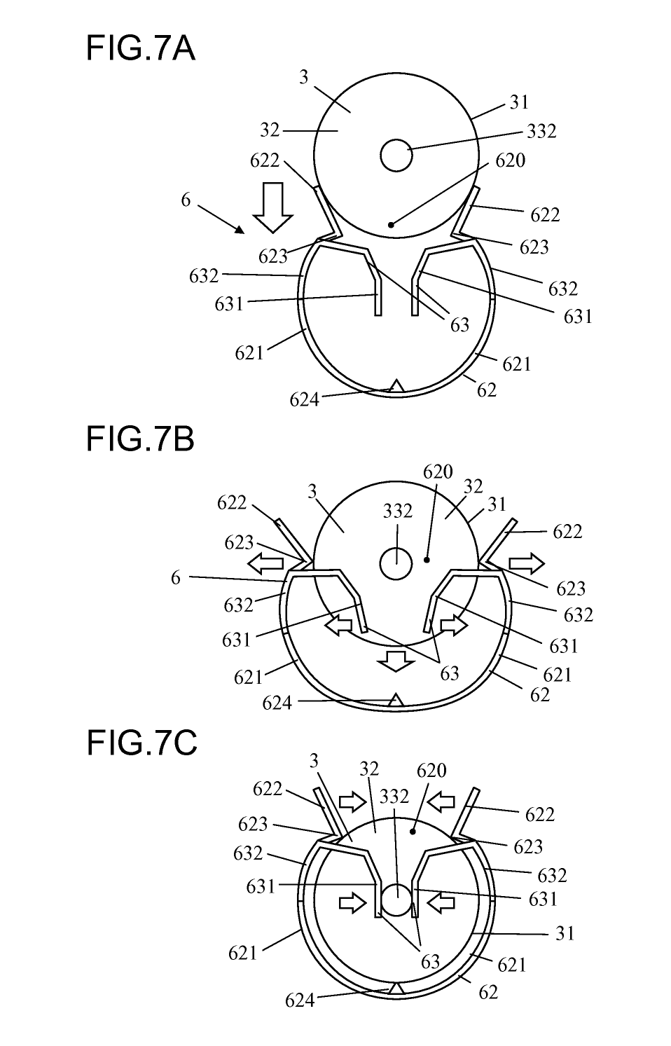

The procedure of fitting the lamp to the lamp connector 6 will now be described with reference to the accompanying drawings. FIGS. 7A to 7C are diagrams showing the procedure of fitting the lamp to the lamp connector 6. For convenience, in FIGS. 7A to 7C, the lamp connector 6 is shown with the housing 61 and the connection portion 625 omitted.

As shown in FIG. 7A, in the fitting of the lamp 3 to the lamp connector 6, the ends of the valve 31 are first brought into contact with the valve guide portions 622, and the outer lead 332 and the feed portions 63 are arranged along a direction in which the lamp is inserted. Part of the valve 31 overlaps the insertion opening 620.

Here, both ends of the valve 31 of the lamp 3 are in contact with the valve guide portions 622 of the lamp connector 6. The outer lead 332 is not in contact with the lamp connector 6. In this state, when the lamp 3 is pressed toward the back (downward in the figure) of the lamp connector 6, the valve guide portions 622 are pressed by the valve 31 in directions in which the insertion opening 620 extends.

When the lamp 3 is continuously pressed, the elastic deformation portions 621 are elastically deformed, and thus the insertion opening 620 extends. As the valve support edge portions 632 move along the outer circumferential surface of the valve 31, the valve 31 moves into the valve holding portion 62. As shown in FIG. 7B, the lead contact portions 631 of the feed portions 63 move apart together with the elastic deformation portions 621; the valve holding portion 62 is deformed until the gap, that is, the insertion opening 620 is equal in size to the outer diameter of the valve 31.

The elastic deformation portions 621 are deformed until the width of the insertion opening 620 is equal to the outer diameter of the valve 31. Then, when the middle portion of the valve 31 moves inward beyond the insertion opening 620, the elastic deformation portions 621, which are elastically deformed by the pressing of the valve 31, move toward each other with the valve support edge portions 623 moving along the outer circumferential surface of the valve 31 due to the restoring force (elastic force) resulting from the deformation. When the valve 31 comes into contact with the valve support projection portion 624, the elastic deformation portions 621 are restored to the original shape (see FIG. 7C).

In this way, the valve 31 is held by the valve holding portion 62. As shown in the figure, the valve 31 is held by the valve holding portion 62 by being supported at three points of the pair of valve support edge portions 623 and the valve support projection portion 624.

On the other hand, when the valve 31 is held by the valve holding portion 62, the feed portions 63 move together with the elastic deformation portions 621. The lead contact portions 631 coupled with the elastic deformation portions 621 through the coupling portions 632 move away from each other as the elastic deformation portions 621 move. When the insertion of the valve 31 is started (in the state of FIG. 7A), the gap between the pair of the lead contact portions 631 is larger than the outer diameter of the outer lead 332, and the lead contact portions 631 and the outer lead 332 are not in contact with each other.

When half of the valve 31 is inserted into the valve holding portion 62, the gap between the lead contact portions 631 is widest. Then, when the valve 31 is further inserted into the valve holding portion 62, the lead contact portions 631 move close to each other as the elastic deformation portions 621 move (deform). Then, when the valve 31 is completely held by the valve holding portion 62 (in other words, when the valve 31 comes into contact with the valve support projection portion 624), the lead contact portions 631 sandwich the outer lead 332 from both sides, and come into contact with it.

As described above, the use of the lamp connector 6 prevents the outer lead 332 from coming into contact with members (for example, the lead contact portions 631) of the lamp connector 6 before the lamp 3 is completely fitted. Thus, it is possible to prevent a large force from being applied to the outer lead 332 when the lamp is fitted, and to prevent the formation of a poor interface between the sealing portion 32 and the lead wire 33 and thus the entrance of air into the valve 31.

As described above, in the lamp holder 6, the valve 31 is held by the valve holding portion 62, and the feed portions 63 are electrically in contact with the outer lead 331. In this state, when a large force resulting from impact or vibration is applied to the valve 31, all the force or almost all the force is transmitted from the valve 31 to the valve holding portion 62, but little force is transmitted from the outer lead 332 to the lead contact portions 631. In other words, with the lamp holder 6, it is possible to prevent a large force from being applied to the lead wire 33 and the lead wire 33 from being separated form the sealing portion 32.

It is preferable to use a pair of lead contact portions 631 that is formed to come into contact with the outer lead 332 on completion of insertion of the valve 31 or when the insertion of the valve 31 is substantially completed. It is also preferable to use a pair of lead contact portions 631 that is slightly and elastically deformed by the outer lead 332 and that is pressed onto the outer lead 332 by such an elastic force resulting from the deformation that a poor interface between the sealing portion 32 and the lead wire 33 is not formed.

### Second Embodiment

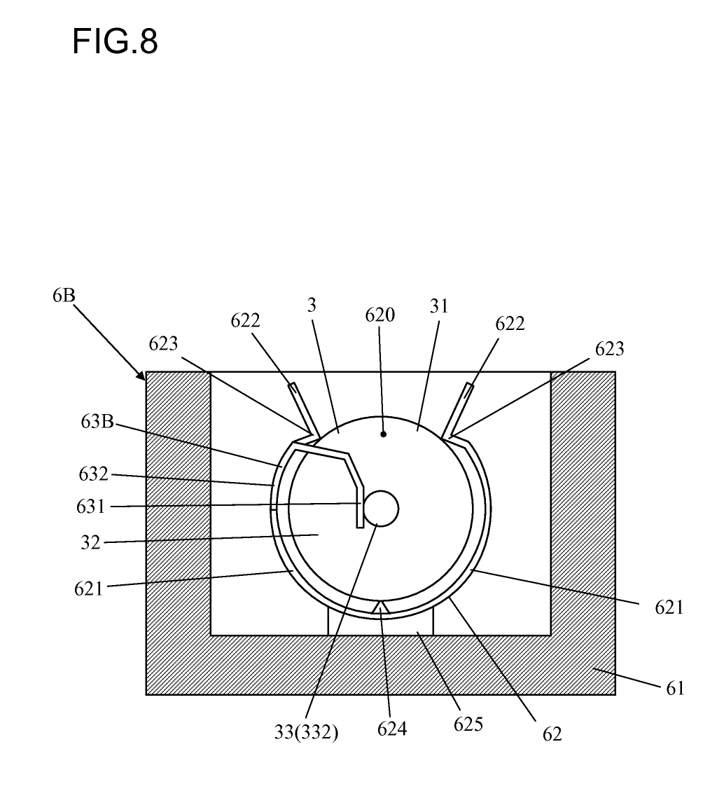

Another embodiment of the lamp connector according to the present invention will be described with reference to the accompanying drawing. FIG. 8 is a schematic side view showing a state where the lamp is fitted to the lamp connector according to the invention. The shape of a lamp connector 63B shown in FIG. 8 is the same as that of the lamp connector 6 described in the first embodiment except for a feed portion 63B; substantially similar parts are identified with like symbols. The detailed description of the substantially similar parts will not be repeated.

The feed portion 63B of the lamp connector 6B has one lead contact portion 631 and one coupling portion 632 that is coupled thereto. The lead contact portion 631 is coupled to one (the left one of FIG. 8 in this embodiment) of the elastic deformation portions 621 through the coupling portion 632. The lead contact portion 631 is formed opposite the coupling portion 632. The lead contact portion 631 is formed to apply such a force to the outer lead 332 that a poor interface between the sealing portion 32 and the lead wire 33 is not formed. Specifically, the lead contact portion 631 is formed to be slightly deformed by being pressed by the outer lead 332 when the lamp 3 is fitted to the lamp connector 6.

The lead contact portion 631 and the coupling portion 632 are members that are produced by bending a metal plate. When the feed portion 63B is provided with one lead contact portion 631 and one coupling portion 632, the position of the lead contact portion 631 with respect to the outer lead 332 needs to be adjusted only one time at the time of production of the lamp connector 6B, and an adjustment for the relative position of the lead contact portions 631 necessary when they are arranged opposite each other is not required, with the result that it is possible to reduce the number of steps in the production.

### Third Embodiment

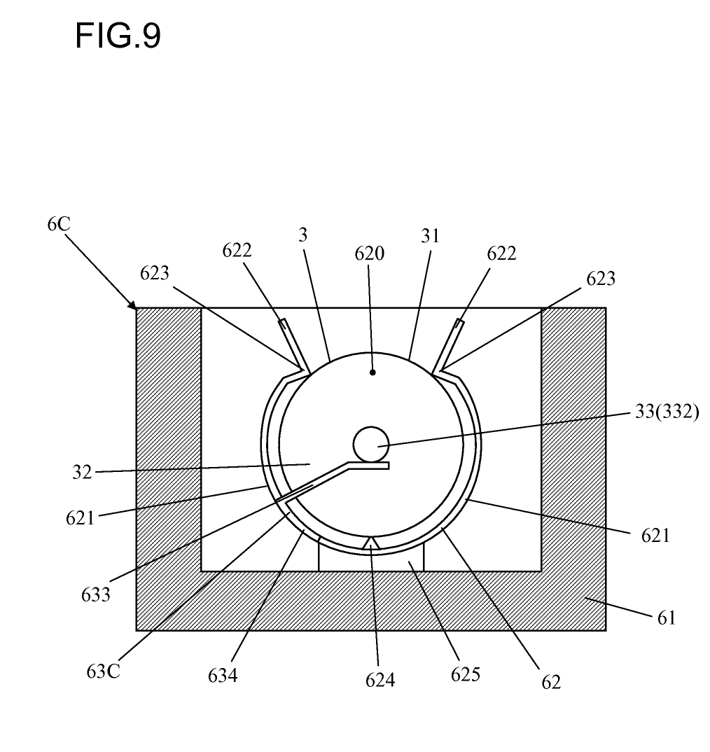

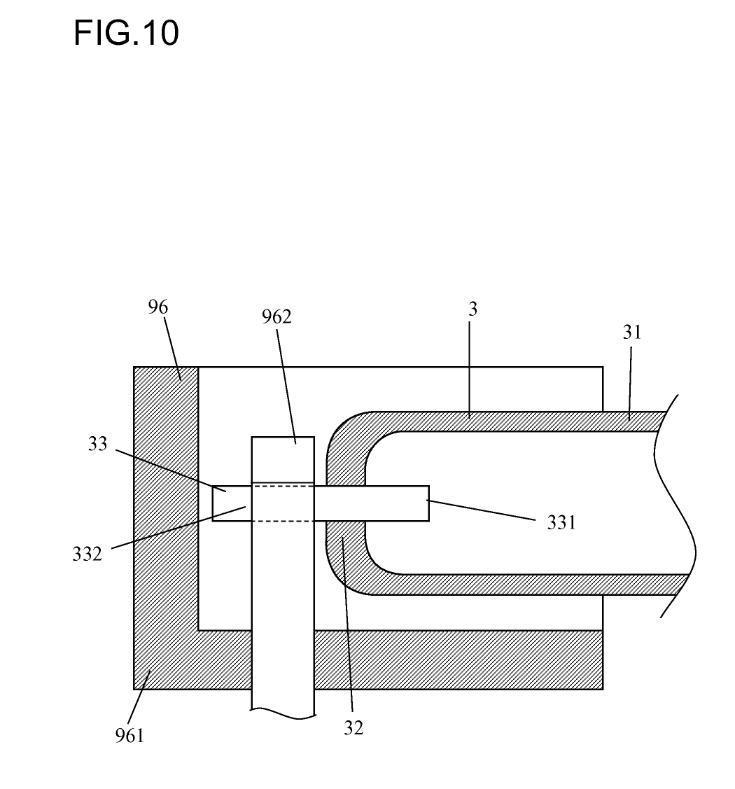

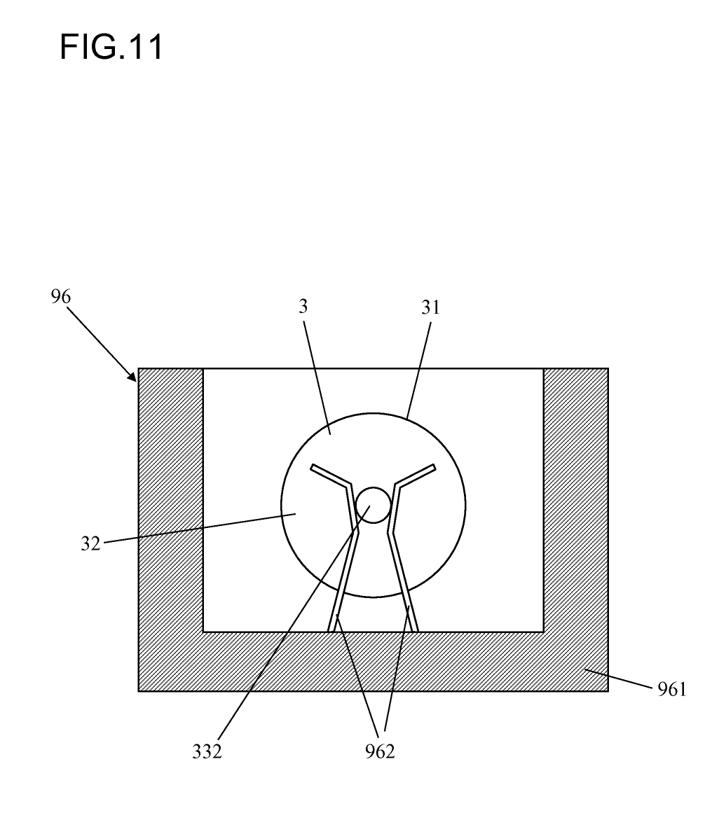

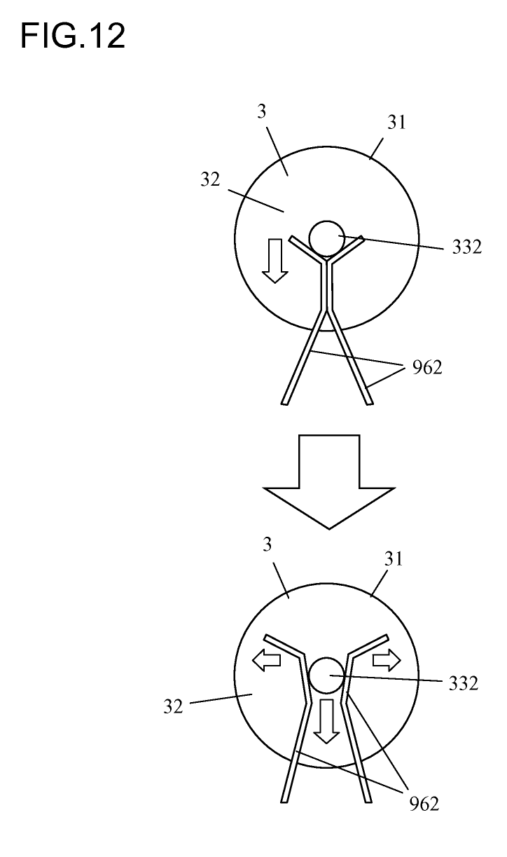

Still another embodiment of the lamp connector according to the present invention will be described with the accompanying drawing. FIG. 9 is a schematic side view showing a state where the lamp is fitted to the lamp connector according to the invention. The shape of a lamp connector C is the same as that of the lamp connector 6 described in the first embodiment except for the feed portion 63C of the lamp connector 6; substantially similar parts are identified with like symbols. The detailed description of the substantially similar parts will not be repeated.

As shown in FIG. 9, the feed portion 63C of the lamp connector 6C has one lead contact portion 633 and a coupling portion 634 that couples the lead contact portion 633 to one of the elastic deformation portions 621. The lead contact portion 633 is formed to extend into the valve holding portion 62, and faces the insertion opening 620.

The lead contact portion 633 is formed to come into contact with the outer lead 332 when the lamp 3 is completely held by the lamp connector 6C. The lead contact portion 633 is formed to apply such a force to the outer lead 332 that a poor interface between the sealing portion 32 and the lead wire 33 is not formed. Specifically, the lead contact portion 633 is formed to be slightly deformed by being pressed by the outer lead 332 when the lamp 3 is fitted to the lamp connector 6C.

Even when the use of the lamp connector 6C having the lead contact portion 633 applies an external force to the lamp 3, and thereby deforms the elastic deformation portions 621 so that they move away from each other, the lead contact portion 633 can keep in contact with the outer lead 332. Thus, it is possible to prevent the failure of power to be supplied to the lamp 332, and thereby prevent the reduction of the brightness and inconsistencies in brightness.

With the lamp connector of the present invention, since the lead contact portion is moved as the elastic deformation portion is deformed when the lamp is fitted, it is possible to prevent a large force from being applied to the outer lead, with the result that it is possible to prevent the formation of a poor interface between the lead wire and the sealing portion. In this way, it is possible to stably light the lamp and thus prevent the reduction of the brightness and inconsistencies in brightness.

With the lamp connector of the present invention, since the valve is supported by the valve support edge portions and the valve support projection portion while the lamp is held by the lamp connector, the outer lead is unlikely to be pressed by the lead contact portion. Thus, even when a force resulting from the load of the lamp itself acts on the lamp or a force resulting from vibration acts thereon, it is possible to prevent the formation of a poor interface between the lead wire and the sealing portion, and thus prevent the reduction of the brightness and inconsistencies in brightness.

Since the valve that has a high temperature during driving is held by the metallic valve holding portion 62, and the heat is transmitted to the valve holding portion and is released out through the valve holding portion, it is possible to prevent the occurrence of a failure (for example, thermal deformation of the housing, the reflective plate or the diffusion plate) resulting from heat being confined.

Although, in the embodiments described above, the valve holding portion and the feed portions are formed integrally, they may be formed otherwise. The valve holding portion and the feed portions are produced separately, and the valve holding portion and the feed portions may be joined by a method of joining the valve holding portion and the feed portions such that they can be conductive, such as welding, bonding or soldering.

Even if the valve holding portion is formed of a non-conductive material, it is preferable that at least a connection portion be formed to be conductive and connected to the feed portions.

Although the present invention is described above with reference to the specific embodiments, the scope of the inventions is not limited to the embodiments, and many modifications are possible without departing from the gist of the invention.

The present invention can be applied to a liquid crystal display device and a backlight device of an image display device having a light source on the back of a liquid crystal display device or the like.

1. A lamp connector that holds a valve in which a low-pressure gas is sealed and an end of a lamp including a lead wire protruding from each end of the valve, the lamp connector comprising:
a valve holding portion including a pair of elastic deformation portions which is arranged opposite each other, whose gap is elastically opened and which sandwiches the valve; and
a feed portion that is coupled to at least one of the elastic deformation portions and that feeds electric power to the lead wire,
wherein the feed portion includes a lead contact portion formed such that, when the pair of elastic deformation portions holds the valve, comes into contact with the lead wire.

2. The lamp connector of claim 1,
wherein the valve holding portion and the feed portion are integrally formed of a conductive material, and electric power is fed to the feed portion through the valve holding portion.

3. The lamp connector of claim 1,
wherein the feed portion includes: a pair of lead contact portions that is provided as the lead contact portion and that is arranged opposite each other; and a coupling portion that couples the pair of lead contact portions to the pair of elastic deformation portions, respectively, and
the lead contact portions are formed to sandwich the lead wire in a same direction as a direction in which the elastic deformation portions sandwich the valve.

4. The lamp connector of claim 1,
wherein the feed portion includes one lead contact portion and a coupling portion that couples the lead contact portion to one of the elastic deformation portions.

5. The lamp connector of claim 4,
wherein the lead contact portion is formed to face the coupling portion and come in contact with the lead wire from a side of the elastic deformation portion to which the coupling portion is coupled.

6. The lamp connector of claim 4,
wherein the lead contact portion is formed to extend in a direction in which the elastic deformation portions sandwich the valve.

7. A backlight device,
wherein the lamp connector of claim 1 is used to hold the lamp.

8. A backlight device,
wherein the lamp connector of claim 3 is used to hold the lamp.

9. A backlight device,
wherein the lamp connector of claim 4 is used to hold the lamp.

10. A backlight device,
wherein the lamp connector of claim 5 is used to hold the lamp.

11. A backlight device,
wherein the lamp connector of claim 6 is used to hold the lamp.

12. A liquid crystal display device comprising:
the backlight device of claim 7.

13. A liquid crystal display device comprising:
the backlight device of claim 8.

14. A liquid crystal display device comprising:
the backlight device of claim 9.

15. A liquid crystal display device comprising:
the backlight device of claim 10.

16. A liquid crystal display device comprising:
the backlight device of claim 11.
